(19) United States
(12) Patent Application Publication
(10) Pub. No.: US 2012/0106026 A1
(43) Pub. Date: May 3, 2012

(54) ELECTRICAL STORAGE DEVICE

(75) Inventors: Toshihiko HIGASHINO, Chiyoda-ku (JP); Fumito UEMURA, Chiyoda-ku (JP); Nobuhiro KIHARA, Chiyoda-ku (JP); Yuichi MURAMOTO, Chiyoda-ku (JP); Takayuki UBUKATA, Chiyoda-ku (JP)

(73) Assignee: MITSUBISHI ELECTRIC CORPORATION, Tokyo (JP)

(21) Appl. No.: 13/037,544

(22) Filed: Mar. 1, 2011

(30) Foreign Application Priority Data
Nov. 2, 2010 (JP) 2010-246307

(51) Int. Cl. H01G 4/38

(52) U.S. Cl. 361/330

(57) ABSTRACT

A electrical storage device has: a cell module including a plurality of cells arranged juxtaposed and each having a pair of current collector terminals protruding from electrodes, the current collector terminals of adjacent ones of the cells being connected to each other; and an electronic circuit board disposed near the cell module and electrically connected to the current collector terminals of each of the cells via a plurality of connecting wires, for controlling charging and discharging of each of the cells. A cable having flexibility or a flexible wire is used as each of the connecting wires. One end of each of the connecting wires has a connecting terminal portion for clamping the current collector terminals of the adjacent ones of the cells to each other.

### BACKGROUND OF THE INVENTION

1. Field of the Invention

The present invention relates to an electrical storage device including a cell module in which a plurality of cells arranged in parallel are electrically connected to each other.

2. Description of the Related Art

The development of applications of an electric double layer capacitor having a plurality of electrical storage means, for example, has been actively sought for various power sources and electrical storage devices in various fields because of the capability that allows charging and discharging in a short time.

However, the withstand voltage (output voltage) of one cell in the electric double layer capacitor is low, about several volts. When using the electric double layer capacitor for a drive or auxiliary power source of an electric vehicle, it is necessary to connect a large number of cells in series and parallel in order to heighten the withstand voltage and increase the capacity.

Each of the cells has current collector terminals protruding from a pair of positive and negative electrodes, and the current collector terminals of adjacent cells are connected to each other, to thereby form a cell module with a predetermined capacity (see Patent Documents 1 and 2).

### REFERENCES

### Patent Documents

[Patent Document 1] JP-A-2000-114121
[Patent Document 2] JP-A-2006-269830

As shown in Patent Document 1, charging and discharging of the electric double layer capacitor may be performed for the electrodes of both ends of the cells connected in series and in parallel. However, a case occurs in which the charge-discharge conditions are not uniform in the cells.

In such a case, an additional controlling means is necessary in order to make the charge-discharge conditions uniform between the cells, and it is necessary to connect each of the cells to an electronic device for controlling the amount of charging and discharging for each of the cells.

In this case, it is conceivable to use a method of extending the length of the current collector terminals of each cell to connect the current collector terminals to the electronic device as the connection method. However, a problem with extending the length of the current collector terminal is that the resistance value of the current collector terminal increases, increasing the resistance value of the device as a whole.

In the case of Patent Document 2, the connection piece, which corresponds to the current collector terminal, is made of a metal wire material or a metal plate material, so the degree of freedom of the plurality of cells is limited. The degree of freedom in the positions of the cells and an electronic circuit board that forms the electronic device is limited in assembling, and therefore, assembling workability is poor. Furthermore, since no flexibility is provided in the connection between the cells and the electronic device, vibration resistance becomes an issue when the device is incorporated, for example, in an electric vehicle.

### SUMMARY OF THE INVENTION

This invention is accomplished in order to solve such problems as described above, and it is an object of the invention to provide an electrical storage device that makes it possible to connect the current collector terminals of each of the cells with the electronic circuit board at a low contact resistance and to keep the connection state continuously, and has vibration resistance over a long time and also offers excellent assembling workability.

The invention provides an electrical storage device having a cell module and an electronic circuit board. The cell module has a plurality of cells arranged juxtaposed and each having a pair of current collector terminals protruding from electrodes. The current collector terminals of adjacent ones of the cells are connected to each other. The electronic circuit board is disposed near the cell module and electrically connected to the current collector terminals of the cells via a plurality of connecting wires. The electronic circuit board controls charging and discharging of each of the cells. In the electrical storage device, each of the connecting wires has flexibility, and one end of each of the connecting wires has a connecting terminal portion for clamping the current collector terminals of the adjacent ones of the cells to each other.

The invention makes available an electrical storage device that makes it possible to connect the current collector terminals of each of the cells with the electronic circuit board that controls charging and discharging of each of the cells at a low contact resistance and to keep the connection state continuously, and has vibration resistance over a long time and also offers excellent assembling workability.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a primary portion perspective view showing the configuration of a first embodiment of the invention.

FIG. 2 is a primary portion perspective view showing another example of the attaching state of the connecting wire in the first embodiment.

FIG. 3 is a primary portion perspective view showing another example of the attaching state of the connecting wire in the first embodiment.

FIG. 4 is an illustrative view showing one example of the state of the connecting wire when in the attaching process and after the assembling.

FIG. 5 is a primary portion perspective view showing the configuration of a second embodiment of the invention.

FIG. 6 is an illustrative view showing one example of the attaching state of the connecting wire in the second embodiment.

FIG. 7 is a primary portion perspective view showing another example of the attaching state of the connecting wire in the second embodiment.

FIG. 8 is a primary portion perspective view showing another example of the attaching state of the connecting wire in the second embodiment.

FIG. 9 is an illustrative view showing one example of the attaching state of the connecting wire in the second embodiment.

FIG. 10 is a perspective view showing one example of the positional relationship between the cells and the electronic circuit board in a second embodiment.

### DETAILED DESCRIPTION OF THE INVENTION

### First Embodiment

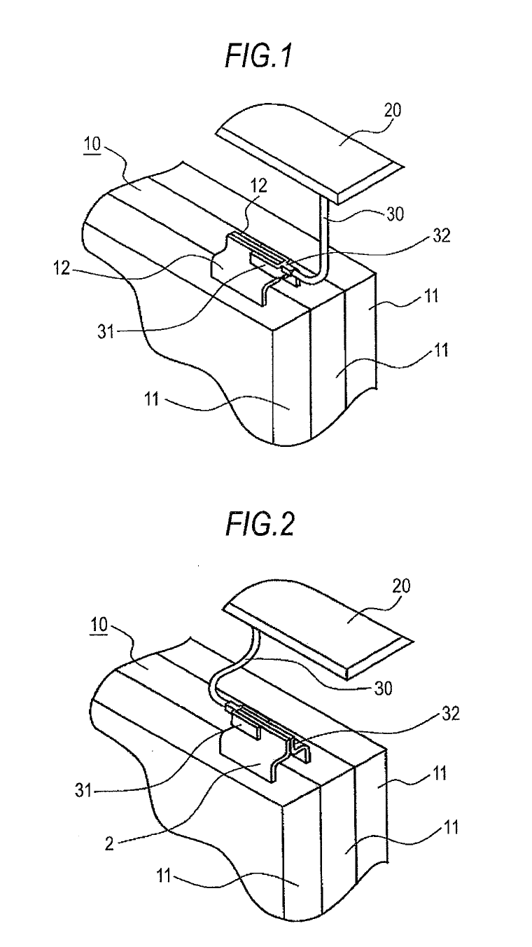

FIG. 1 is a primary portion perspective view showing the configuration of a first embodiment of the invention. FIG. 1 shows a case in which a cell module 10 is constructed by connecting in series a plurality of (three in the figure) cells 11 arranged juxtaposed, each of the cells including an electric double layer capacitor.

Each of the cells 11 has a pair of current collector terminals 12 protruding from the positive and negative electrodes. The current collector terminals of different polarities adjacent to each other are ultrasonic welded so as to be superposed on each other.

For joining the superposed current collector terminals 12, it is possible to use other means than ultrasonic welding, such as laser welding, resistance welding, and soldering.

Depending on the application, it is also possible that the current collector terminals of the same polarity adjacent to each other may be superposed on each other to effect a parallel connection.

Moreover, although not shown in FIG. 1 for convenience, the two endmost cells of the plurality of cells 11 connected to each other are configured so that the current collector terminals of the adjacent cells are not connected to the endmost cells, and the two ends serve the two electrodes of the cell module.

The current collector terminals 12 superposed on and connected to each other are connected to an electronic circuit board 20 for controlling charging and discharging of each of the cells 11 via a the cable 30 constructed of a stranded wire. The cable 30 has a substantially U-shaped connecting terminal portion 31 at its one end, which clamps together the current collector terminals 12 of adjacent cells from a sideward direction along the electronic circuit board 20.

A crimp contact 32 is formed on the connecting terminal portion 31. The crimp contact 32 crimps and secures the stranded wire of the cable 30.

On the other hand, the other end of the cable 30 is electrically and mechanically connected to the electronic circuit board 20 by, for example, a connector (not shown).

Since the connecting terminal portion 31 has a substantially U-shape for clamping the side faces of the superposed current collector terminals 12, the connecting terminal portion 31 makes the positioning thereof with respect to the current collector terminals 12 easy and also offers excellent workability.

It should be noted that although ultrasonic welding is suitable for joining of the current collector terminals 12 and the connecting terminal portion 31, it is possible to employ laser welding, resistance welding, soldering, and the like. In addition, it is possible to simultaneously carry out the joining of the current collector terminals 12 with the connecting terminal portion 31 and joining of the current collector terminals with each other. However, in that case, it is desirable that the sizes of the portions to be joined be the same or similar.

For convenience in illustration, a configuration example has been shown in which the current collector terminals 12 of a pair of the cells 11 are connected in series. However, in reality, a plurality of current collector terminals 12 exist. Since the distances from the electronic circuit board 20 to the respective current collector terminals 12 are different, it becomes possible to identify the current collector terminals 12 when fitting the cables 30 by adjusting the lengths of the cables 30 respectively.

FIGS. 2 to 4 show various examples of the method of connecting the current collector terminals 12 with the cable 30. In FIG. 2, the orientation of the connecting terminal portion 31 of the cable 30 is set near the center of the cell 11. This is effective when the space between the end face of the cell 11 and the current collector terminal 12 is small.

In addition, when the arrangement position of the current collector terminal 12 is at the side face of the cell 11, the connecting terminal portion 31 is allowed to clamp the current collector terminals 12 from the upward direction opposing the electronic circuit board 20 by setting the orientation of the connecting terminal portion 31 near the center of the cell 11. Thereby, workability is improved. This is made possible by using a cable 30 having flexibility for the connecting wire for connecting the electronic circuit board 20 with the current collector terminals 12.

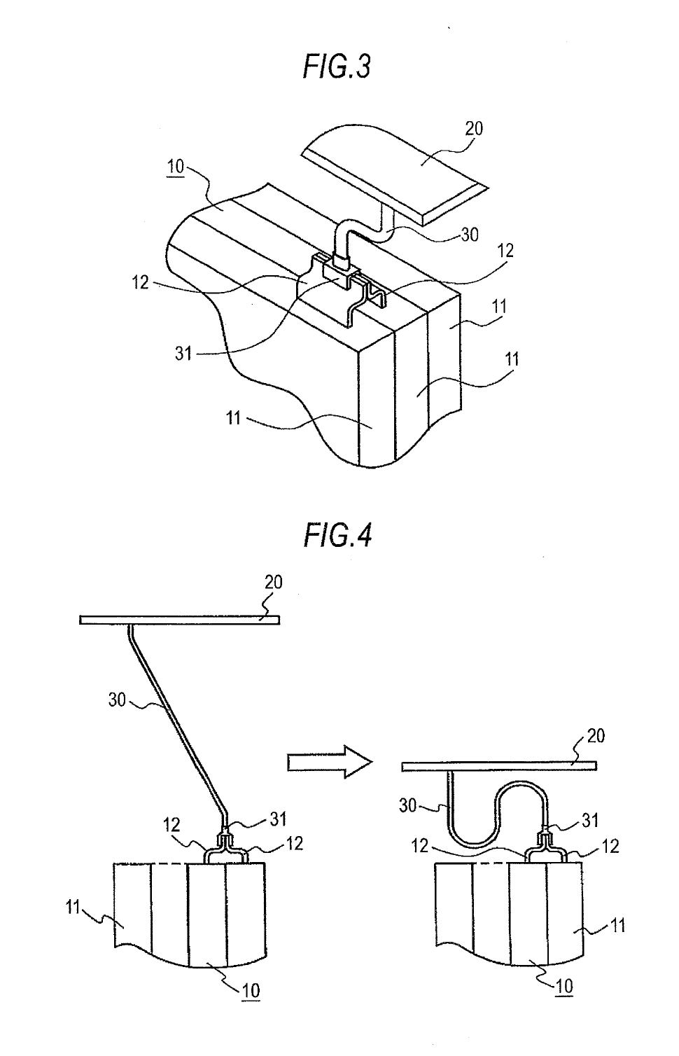

In FIG. 3, the connecting terminal portion 31 is connected to the upper portions of the current collector terminals 12. As with the examples of FIGS. 1 and 2, a certain space is necessary when connecting the current collector terminals 12 with the connecting terminal portion 31, taking workability into consideration. However, if the space is too large, a problem arises that the device as a whole becomes large. As shown in FIG. 4, heightwise size reduction can be achieved by ensuring a certain space in working and folding the cable 30 in assembling. This is made possible by using a cable 30 having flexibility for the connecting wire.

As described above, according to the first embodiment of the invention, the electrical storage device has: a cell module 10 including a plurality of cells 11 arranged juxtaposed and each having a pair of current collector terminals 12 protruding from electrodes, the current collector terminals 12 of adjacent ones of the cells 11 being connected to each other; and an electronic circuit board 20 disposed near the cell module 10 and electrically connected to the current collector terminals 12 of the cells 11 via a plurality of connecting wires, for controlling charging and discharging of each of the cells 11, wherein a cable having flexibility is used for each of the connecting wires, and one end of each of the connecting wires has a connecting terminal portion 31 for clamping the current collector terminals 12 of the adjacent ones of the cells 11 to each other. Therefore, it is possible to obtain an electrical storage device that makes it possible to connect the current collector terminals 12 of each of the cells 11 with the electronic circuit board 20 at a low contact resistance and to keep the connection state continuously, and has vibration resistance over a long time and also offers excellent assembling workability.

### Second Embodiment

FIG. 5 is a primary portion perspective view showing the configuration of a second embodiment of the invention. FIG. 5 shows an example in which a sheet-shaped flexible wire 40 is used as the connecting wire for connecting the current collector terminals 12 of each of the cells 11 with the electronic circuit board 20 for controlling charging and discharging of each of the cells 11, to directly connect the connecting wire to the current collector terminals 12.

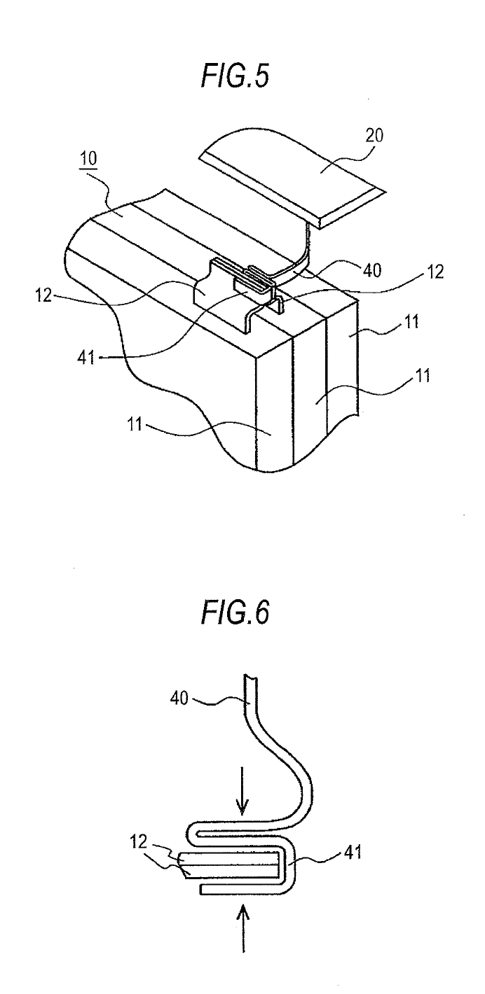

In FIG. 5, a connecting terminal portion 41 of the sheet-shaped flexible wire 40 has such a shape that the flexible wire is folded several times so as to clamp the current collector terminals 12. The connecting terminal portion 41 is connected to a side face of the current collector terminal 12 from a direction along the electronic circuit board 20. The concentration of stress of the connecting terminal portion 41 is alleviated by folding the flexible wire several times. In order to increase the joining force of the current collector terminals 12 and the connecting terminal portion 41, it is effective to use a method of keeping the state in which the sheet-shaped flexible wire 40 is folded several times and joining the sheet-shaped flexible wire 40 with the current collector terminals 12 at the folded portion from outside, as shown in FIG. 6.

The sheet-shaped flexible wire 40 is a planar body. For this reason, when the sheet-shaped flexible wire 40 is connected to the current collector terminals 12 from a horizontal direction, it is necessary to rotate the sheet-shaped flexible wire 40 90 degrees in a plane direction in order to connect the sheet-shaped flexible wire 40 to the electronic circuit board 20 positioned above. This is made possible because the sheet-shaped flexible wire 40 has flexibility.

Ultrasonic welding is suitable for connecting the current collector terminals 12 with the sheet-shaped flexible wire 40. In this case, as mentioned above, it is possible to simultaneously carry out the connecting of the current collector terminals 12 with the sheet-shaped flexible wire and the connecting of the current collector terminals 12 with each other.

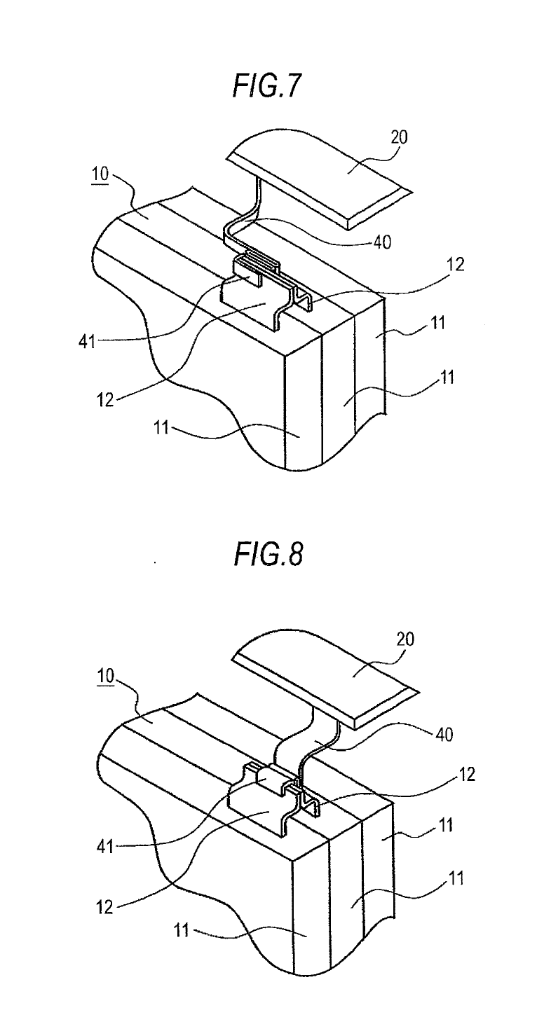

FIG. 7 shows an example in which side faces of the current collector terminals 12 are clamped by the connecting terminal portion 41 of the flexible wire 40 from a sideward direction along the electronic circuit board 20. This example achieves the same advantageous effects as in the case of FIG. 2.

FIG. 8 shows an example in which the current collector terminals 12 are clamped by the connecting terminal portion 41 of the flexible wire 40 from the upward direction opposing the electronic circuit board 20. This example achieves the same advantageous effects as in the case of FIG. 3.

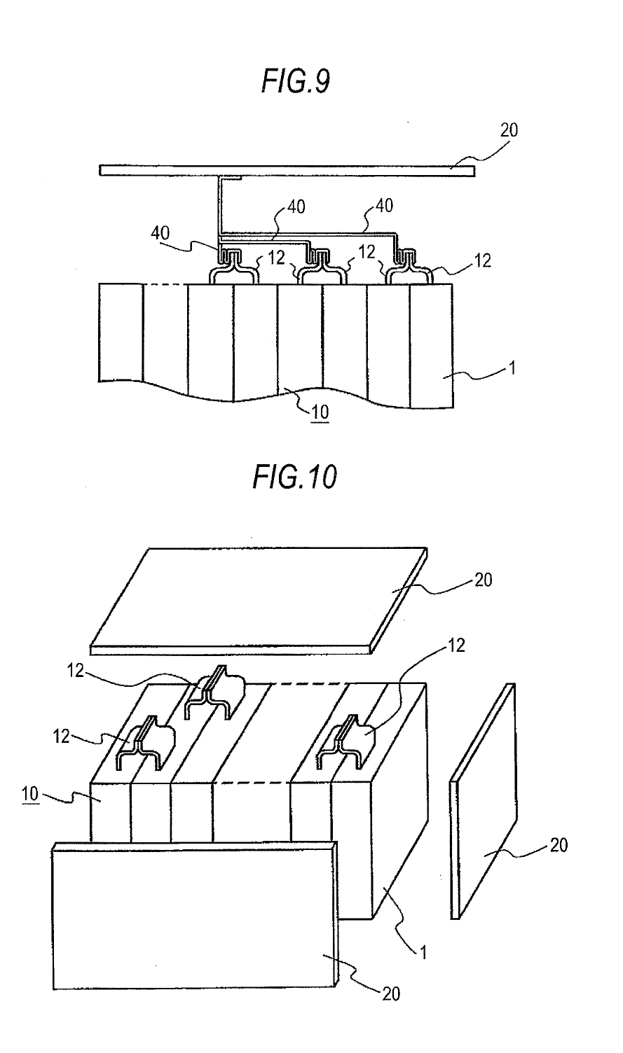

FIG. 9 shows an example in which the current collector terminals 12 of the cells 11 in the cell module 10 are connected to the electronic circuit board 20 via a plurality of flexible wires 40.

A plurality of the flexible wires 40 are bundled integrally and attached to the electronic circuit board 20 at a connecting portion with the electronic circuit board 20. That state is maintained approximately to the point near the center to be attached to a plurality of the current collector terminal 12. From that point onward, the flexible wires 40, branched at that point, are connected separately one by one, to respective current collector terminals 12 at different lengths because the distances to the respective current collector terminals 12 are different. In other words, the flexible wires 40 have different lengths independently from one another according to the arrangement positions of the current collector terminals 12 of the adjacent ones of the cells.

When using the cable 30 as used in the first embodiment, it is also possible to employ the same configuration as that in FIG. 9.

In the drawings, the arrangement position of the electronic circuit board 20 is shown to be above the cell module 10 as a representative example. However, depending on circumstances, it is also conceivable to dispose the electronic circuit board 20 at a side face of the cell module 10, as illustrated in FIG. 10. In either case of the positional relationships, it is possible to obtain an electrical storage device having vibration resistance and excellent workability by using a connecting wire having flexibility for connecting the current collector terminals 12 with the electronic circuit board 20.

Various modifications and alterations of this invention will be apparent to those skilled in the art without departing from the scope and spirit of this invention, and it should be understood that this is not limited to the illustrative embodiments set forth herein.

What is claimed is:

1. An electrical storage device comprising: a cell module including a plurality of cells arranged juxtaposed and each having a pair of current collector terminals protruding from electrodes, the current collector terminals of adjacent ones of the cells being connected to each other; and an electronic circuit board disposed near the cell module and electrically connected to the current collector terminals of the cells via a plurality of connecting wires, for controlling charging and discharging of each of the cells, wherein each of the connecting wires has flexibility, and one end of each of the connecting wires has a connecting terminal portion for clamping the current collector terminals of the adjacent ones of the cells to each other.

2. The electrical storage device according to claim 1, wherein the connecting wire comprises a plurality of cable wires, and the connecting terminal portion has a crimp contact for crimping and securing the plurality of cable wires.

3. The electrical storage device according to claim 1, wherein the connecting wire comprises a sheet-shaped flexible wire, and the connecting terminal portion is formed by folding one end of the flexible wire a plurality of times.

4. The electrical storage device according to claim 1, wherein the connecting terminal portion has a substantially U-shape, and the connecting terminal portion clamps together the current collector terminals of adjacent ones of the cells from a direction along the electronic circuit or from a direction opposing the electronic circuit.

5. The electrical storage device according to claim 1, wherein the connecting wires have different lengths independently from one another according to arrangement positions of the current collector terminals of the adjacent ones of the cells.

6. The electrical storage device according to claim 1, wherein each of the cells is an electric double layer capacitor.
